(19) United States
(12) Patent Application Publication
(10) Pub. No.: US 2026/0178739 A1
(43) Pub. Date: Jun. 25, 2026

(54) PRIORITIZED PATCH MANAGEMENT IN A DATACENTER

(71) Applicant: Dell Products L.P., Round Rock, TX (US)

(72) Inventors: Abhishek Mishra, Bangalore (IN); Vivek Bhargava, Bangalore (IN); Bhupendra Kumar Pal, Mathura (IN)

(73) Assignee: Dell Products L.P., Round Rock, TX (US)

(21) Appl. No.: 18/987,138

(22) Filed: Dec. 19, 2024

(51) Int. Cl. G06F 21/57; G06F 21/55

(52) U.S. Cl. CPC G06F 21/577; G06F 21/552; G06F 21/572

(57) ABSTRACT

Methods and systems are provided for managing a datacenter. Profiles are maintained for hardware systems operating in the datacenter. A new security threat to one or more of the hardware systems operating in the datacenter is identified. The security threat is assigned a datacenter threat score that characterizes the vulnerability of the datacenter to the security threat based on the hardware systems operating in the datacenter. The hardware systems operating in the datacenter are classified based on their relative vulnerability to the security threat. Patching for each of the hardware systems operating in the datacenter is prioritized based on one or more vulnerability hyperplanes that are identified in the vulnerability classification of the hardware systems operating in the datacenter.

### FIELD

The present disclosure relates generally to Information Handling Systems (IHSs), and relates more particularly to configuring IHSs that are deployed in a datacenter.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as enterprise-class servers that are stacked and installed within racks. Each server IHS within a data center may support a wide variety of possible hardware and software configurations. In some instances, IHSs, such as rack-mounted servers may be grouped into computing clusters that may also include other types of hardware components, such as network switches and power supplies that can enhance the capabilities of the computing cluster. Accordingly, a data center may include a wide variety of different hardware components. Further complicating datacenter management is the regular replacement and re-configuration of server IHSs and other hardware, such that the hardware systems operating in a datacenter are constantly changing.

### SUMMARY

In various embodiments, methods and systems are provided for managing a datacenter including a plurality of IHSs (Information Handling Systems). Embodiments may include: maintaining profiles for hardware systems operating in the datacenter; detecting a security threat to one or more of the hardware systems operating in the datacenter; assigning the security threat a datacenter threat score that characterizes the vulnerability of the datacenter to the security threat based on the hardware systems operating in the datacenter; classifying the hardware systems operating in the datacenter based on their relative vulnerability to the security threat; and prioritizing patching for each of the hardware systems operating in the datacenter based on a plurality of vulnerability hyperplanes that are identified in the vulnerability classification of the hardware systems operating in the datacenter.

In some embodiments, the datacenter threat score is generated from CVSS (Common Vulnerability Scoring System) metrics that characterize the vulnerability of the datacenter to security threats. In some embodiments, the CVSS metrics are utilized as inputs to an Adaptive Neuro Fuzzy Inference System (ANFIS) that generates the datacenter threat score as an output. In some embodiments, the CVSS metrics comprise a first target distribution metric for IHS server hardware systems that are operating in the datacenter. In some embodiments, the CVSS metrics comprise a second target distribution metric for network switch hardware systems that are operating in the datacenter. In some embodiments, the hardware systems operating within the datacenter comprise the plurality of IHSs and a plurality of network switches. In some embodiments, the hardware systems operating in the datacenter are classified according to the vulnerability to the security threat through operation of a Random Forest Classifier. In some embodiments, the Random Forest Classifier utilizes as inputs the datacenter threat score and the profiles maintained for the hardware systems operating in the datacenter. In some embodiments, the vulnerability hyperplanes segregate the classified hardware systems into prioritized groupings of the hardware systems operating in the datacenter. In some embodiments, the vulnerability hyperplanes are identified through operation of a Support Vector Classifier. In some embodiments, vectors used by the Support Vector Classifier in classifying the hardware systems operating in the datacenter into one of the prioritized groupings comprise an importance of respective hardware systems to overall datacenter operations.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a diagram illustrating certain components of a chassis, according to some embodiments, that includes multiple IHSs that may be configured as members of a computing cluster that support prioritized datacenter patch management.

FIG. 2 is a diagram illustrating certain components of an IHS configured, according to some embodiments, to support prioritized datacenter patch management.

FIG. 3 is a flowchart illustrating certain steps of methods, according to some embodiments, for prioritized datacenter patch management.

### DETAILED DESCRIPTION

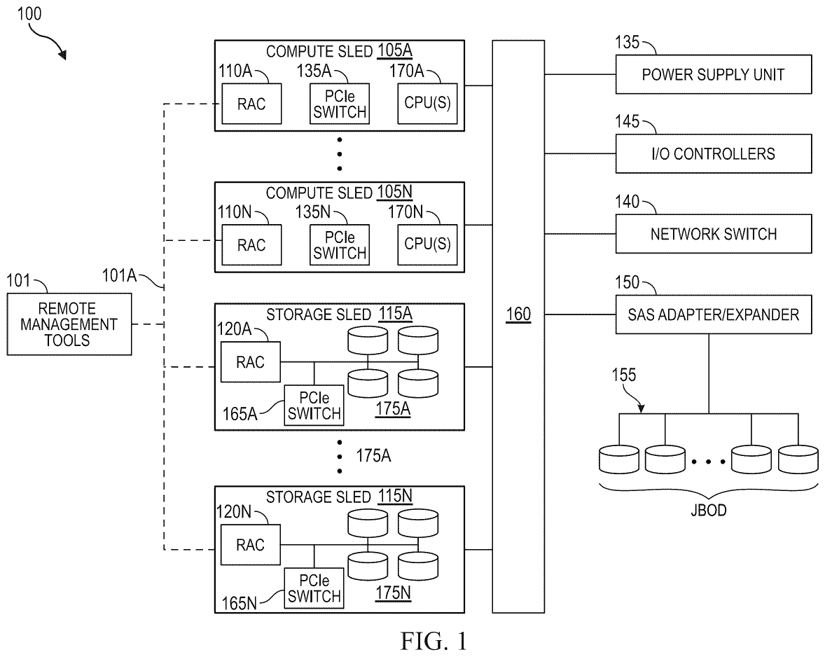

FIG. 1 is a block diagram illustrating certain components of a chassis 100 comprising one or more compute sleds 105a-n and one or more storage sleds 115a-n that may be collectively and/or individually configured to implement the systems and methods described herein for prioritized datacenter patch management. As described, a datacenter may include many rack-mounted chassis 100, where each chassis 100 may outwardly appear relatively similar to neighboring chassis, but each chassis may include differing, and sometimes highly specialized, hardware. As security vulnerabilities, such as bugs or other flaws, are identified within the computing community, it is important to apply appropriate patches (e.g., firmware or other software updates) within the data center. However, determining which hardware systems to prioritize in applying patches is exceedingly difficult for data center administrators in light of the multitude of different hardware configurations in use within a datacenter, and further complicated by the ongoing replacement and addition of hardware that is in use within a datacenter. Accordingly, embodiments provide capabilities for prioritizing hardware systems within the datacenter for the application of patches that have become available for addressing vulnerabilities that have been identified with respect to the datacenter hardware systems, where these prioritizations may be based on classifications of the datacenter hardware systems according to their relative vulnerabilities to an identified security threat.

Embodiments of chassis 100 may include a wide variety of different hardware configurations. Such variations in hardware configuration may result from chassis 100 being factory configured to include components specified by a customer that has contracted for manufacture, provisioning and delivery of the chassis 100. Configured in this manner, a chassis 100 may be tasked as a single entity that combines the capabilities of the sleds 105a-n, sleds 115a-n and/or other hardware that is included in the chassis 100, such as network switches 140 and power supplies 135.

All of the hardware components of the chassis 100 may be installed within a rack 100 may include one or more slots that each receive an individual sled (that may be additionally or alternatively referred to as a server, node and/or blade), such as compute sleds 105a-n and storage sleds 115a-n. A rack may support a variety of different numbers, sizes (e.g., 1RU, 2RU) and physical configurations of slots. Chassis 100 embodiments may support additional types of sleds that may be installed within a rack and provide various types of storage and/or processing capabilities. Sleds may be individually installed and removed from a rack, thus allowing the computing and storage capabilities of a rack, and thus of a chassis 100, to be reconfigured, in many cases without affecting the operation of the other hardware installed in the rack.

The modular architecture provided by the chassis 100 allows for certain resources, such as cooling, power and network bandwidth, to be shared by the compute sleds 105a-n and storage sleds 115a-n or other hardware installed in the rack, thus providing efficiency improvements and supporting greater computational loads. The rack may provide all or part of the cooling utilized by sleds 105a-n, 115a-n of a chassis 100. For airflow cooling, a chassis 100 may include one or more banks of cooling fans that may be operated to ventilate heated air away from the hardware that is installed within the chassis. In some embodiments, chassis 100 may include liquid cooling manifolds that can be connected to IHSs or other hardware in providing these components with liquid cooling capabilities.

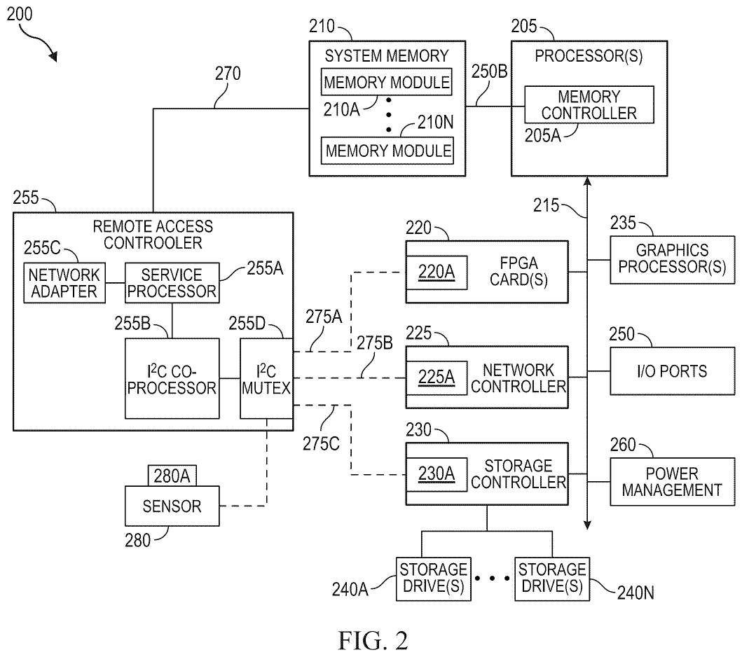

In certain embodiments, a compute sled 105a-n may be an IHS such as described with regard to IHS 200 of FIG. 2. A compute sled 105a-n may provide computational processing resources that may be used to support a variety of e-commerce, multimedia, business and scientific computing applications, such as services provided via a cloud implementation. Compute sleds 105a-n are typically configured with hardware and software that provide leading-edge computational capabilities. Accordingly, services provided using such computing capabilities are typically provided as high-availability systems that operate with minimum downtime. As described in additional detail with regard to FIG. 2, compute sleds 105a-n may be configured for general-purpose computing or may be optimized for specific computing tasks.

As described with regard to FIG. 2, a compute sled IHS 105a-n may include a variety of different hardware components that may be each be individually patched in order to address security or other vulnerabilities. In some embodiments, each compute sled IHS 105a-n may include capabilities for generating an initial evaluation of the sled's vulnerability to an identified security threat, where this initial evaluation is then adjusted in prioritizing the sled, or it's individual hardware components, with regard to installing an available patch.

As illustrated, each compute sled 105a-n includes a remote access controller (RAC) 110a-n. As described in additional detail with regard to FIG. 2, remote access controller 110a-n provides capabilities for remote monitoring and management of compute sled 105a-n. In support of these monitoring and management functions, remote access controllers 110a-n may utilize both in-band and sideband (i.e., out-of-band) communications by compute sled 105a-n. Remote access controllers 110a-n may collect various types of sensor data, such as collecting temperature sensor readings that are used in support of airflow cooling of the sleds 105a-n, 115a-n. In addition, each remote access controller 110a-n may implement various monitoring and administrative functions related to compute sleds 105a-n that utilize sideband bus connections with various internal components of the respective compute sleds 105a-n.

Implementing computing clusters that span multiple processing components (e.g., 105a-n, 115a-n) of one or more chassis 100 may be aided by high-speed data links between these processing components, such as PCIe connections that form one or more distinct PCIe switch fabrics 160 that may implemented by network switches 140 and PCIe switches 135a-n, 165a-n installed in the IHSs 105a-n. These high-speed data links may be used to support software that operates spanning multiple processing, networking and storage components of a chassis 100.

As illustrated, chassis 100 may also include one or more storage sleds 115a-n that may be installed within one or more slots of a rack, in a similar manner to compute sleds 105a-n. Each of the individual storage sleds 115a-n may include various different numbers and types of storage devices. For instance, storage sleds 115a-n may include SAS (Serial Attached SCSI) magnetic disk drives, SATA (Serial Advanced Technology Attachment) magnetic disk drives, solid-state drives (SSDs) and other types of storage drives in various combinations. As illustrated, each storage sled 115a-n includes a remote access controller (RAC) 120a-n provides capabilities for remote monitoring and management of respective storage sleds 115a-n. In some embodiments, each of the storage sleds 115a-n may include a PCIe switch 165a-n for use in coupling the sleds to a switch fabric 160, by which the storage sleds may interface with other computing components of chassis 100.

In the same manner as compute sleds IHS 105a-n, each storage sled 115a-n may include a variety of different hardware components that may be each be individually patched in order to address security or other vulnerabilities. In some embodiments, each storage sled 115a-n may include capabilities for generating an initial evaluation of the sled's vulnerability to an identified security threat, where this initial evaluation is then adjusted in prioritizing the sled, or it's individual hardware components, with regard to installing an available patch.

The remote access controllers 110a-n, 120a-n that are present in a computing cluster 100 may support secure connections with remote management tools 101. In some embodiments, remote management tools 101 provides a remote administrator, whether manual or automated, with various capabilities for remotely administering the operation of an individual IHS or of the computing cluster 100, including initiating updates to the software and hardware operating in the cluster. The remote management tools 101 may also include various monitoring interfaces for evaluating telemetry data collected by the remote access controllers 110a-n, 120a-n. In some embodiments, remote management tools 101 may communicate with remote access controllers 110a-n, 120a-n via a protocol such the Redfish remote management interface.

As described in additional detail below, through the operation of remote management tools 101, a human and/or automated administrator may be tasked with management of patching security or other vulnerabilities within the data center. Through embodiments, the application of available patches throughout the datacenter may be prioritized based on the relative vulnerabilities of the datacenter components, thus providing a remote management tool that minimizes the vulnerabilities that are currently present in the datacenter. In some embodiments, such remote management tools may interface with individual remote access controllers 110a-n, 120a-n of the chassis 100 in collecting initial vulnerability evaluations for individual components of the chassis.

As illustrated, the chassis 100 of FIG. 1 includes a network switch 140 that may provide network access to the sleds 105a-n, 115a-n of the cluster. Network switch 140 may include various switches, adapters, controllers and couplings used to connect computing cluster 100 to a network and/or to local IHSs, such as another computing cluster 100 according to embodiments. Whereas the illustrated embodiment of FIG. 1 includes a single network switch in a computing cluster 100, different embodiments may operate using different numbers of network switches.

In some embodiments, chassis 100 may include one or more power supply units 135 that provides the components of the chassis with various levels of DC power from an AC power source or from power delivered via a power system that may be provided by a rack within which the chassis is installed. In certain embodiments, power supply unit 135 may be implemented within a sled that may provide the chassis 100 with multiple redundant, hot-swappable power supply units. In some embodiments, a power supply unit 135 may be uniquely identified based on a code or other identifier that may be permanently encoded in a non-volatile memory of the power supply unit 135 by its manufacturer.

In addition to the data storage capabilities provided by storage sleds 115a-n, chassis 100 include other storage resources that may be installed within a rack housing the computing cluster 100, such as within a storage blade. In certain scenarios, such storage resources 155 may be accessed via a SAS expander 150 that is coupled to the switch fabric 160 of the chassis 100. The SAS expander 150 may support connections to a number of JBOD (Just a Bunch Of Disks) storage drives 155 that may be configured and managed individually and without implementing data redundancy across the various drives 155. In some embodiments, the data storage resources 155 of a JBOD accessed by the chassis 100 may be utilized in a virtualized manner by cloud systems, such as software defined storage systems.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

FIG. 2 shows an example of an IHS 200 configured to implement systems and methods described herein to support datacenter patch management. It should be appreciated that although the embodiments described herein may describe an IHS that is a compute sled or similar computing component that may be deployed within slots of a rack, other embodiments may be utilized with other types of IHSs that may also be members of a chassis 100 according to embodiments. In the illustrative embodiment of FIG. 2, IHS 200 may be a computing component, such as compute sled 105a-n or other type of server, such as an 1RU server installed within a 2RU chassis, that is configured to share infrastructure resources provided by a rack.

As described, an IHS 200 may be assembled and provisioned according to customized specifications provided by a customer. The IHS 200 of FIG. 2 may be a compute sled, such as compute sleds 105a-n of FIG. 1, that may be installed within a rack in a data center. Installed in this manner, IHS 200 may utilize shared power, network and cooling resources provided by the rack. Embodiments of IHS 200 may include a wide variety of different hardware configurations. Such variations in hardware configuration may result from IHS 200 being factory assembled to include components specified by a customer that has contracted for manufacture and delivery of IHS 200.

IHS 200 may include capabilities that allow a customer to validate that the hardware components of IHS 200 are the same hardware components that were installed at the factory during its manufacture, where these validations of the IHS hardware may be initially completed using a factory-provisioned inventory certificate. An IHS 200 may include capabilities that allow, during initialization of the IHS, validation of the detected hardware of the IHS as being the same factory installed and provisioned hardware that was factory provisioned. As described in additional detail below, embodiments classify the IHS 100 and/or individual hardware components of an IHS according to their relative vulnerability to an identified threat, where such classifications may be based in part on security characteristics of an IHS, as specified in the device profile(s) maintained for the IHS. In some embodiments, these vulnerability classifications may be based in part on whether the authenticity of the hardware of an IHS may be validated using a factory provisioned inventory certificate.

IHS 200 may utilize one or more processors 205. In some embodiments, processors 205 may include a main processor and a co-processor, each of which may include a plurality of processing cores that, in certain scenarios, may each be used to run an instance of a server process. In certain embodiments, one or all of processor(s) 205 may be graphics processing units (GPUs) in scenarios where IHS 200 has been configured to support functions such as multimedia services and graphics applications.

As illustrated, processor(s) 205 includes an integrated memory controller 205a that may be implemented directly within the circuitry of the processor 205, or the memory controller 205a may be a separate integrated circuit that is located on the same die as the processor 205. The memory controller 205a may be configured to manage the transfer of data to and from the system memory 210 of the IHS 205 via a high-speed memory interface 205b. The system memory 210 is coupled to processor(s) 205 via a memory bus 205b that provides the processor(s) 205 with high-speed memory used in the execution of computer program instructions by the processor(s) 205. Accordingly, system memory 210 may include memory components, such as static RAM (SRAM), dynamic RAM (DRAM), NAND Flash memory, suitable for supporting high-speed memory operations by the processor(s) 205. In certain embodiments, system memory 210 may combine both persistent, non-volatile memory and volatile memory.

In certain embodiments, the system memory 210 may be comprised of multiple removable memory modules. The system memory 210 of the illustrated embodiment includes removable memory modules 210a-n. Each of the removable memory modules 210a-n may correspond to a printed circuit board memory socket that receives a removable memory module 210a-n, such as a DIMM (Dual In-line Memory Module), that can be coupled to the socket and then decoupled from the socket as needed, such as to upgrade memory capabilities or to replace faulty memory modules. Other embodiments of IHS system memory 210 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 205. All or portions of the chipset may be implemented directly within the integrated circuitry of an individual processor 205. The chipset may provide the processor(s) 205 with access to a variety of resources accessible via one or more in-band buses 215. Various embodiments may utilize any number of buses to provide the illustrated pathways served by in-band bus 215. In certain embodiments, in-band bus 215 may include a PCIe (PCI Express) switch fabric that is accessed via a PCIe root complex. IHS 200 may also include one or more I/O ports 250, such as PCIe ports, that may be used to couple the IHS 200 directly to other IHSs, storage resources and/or other peripheral components.

As illustrated, IHS 200 may include one or more FPGA (Field-Programmable Gate Array) cards 220. Each of the FPGA card 220 supported by IHS 200 may include various processing and memory resources, in addition to an FPGA logic unit that may include circuits that can be reconfigured after deployment of IHS 200 through programming functions supported by the FPGA card 220. Through such reprogramming of such logic units, each individual FGPA card 220 may be optimized to perform specific processing tasks, such as specific signal processing, security, data mining, and artificial intelligence functions, and/or to support specific hardware coupled to IHS 200. In some embodiments, a single FPGA card 220 may include multiple FPGA logic units, each of which may be separately programmed to implement different computing operations, such as in computing different operations that are being offloaded from processor 205. The FPGA card 220 may also include a management controller 220a that may support interoperation with the remote access controller 255 via a sideband device management bus 275a.

Processor(s) 205 may also be coupled to one or more network controllers 225 via in-band bus 215, such as provided by a Network Interface Controller (NIC) that allows the IHS 200 to communicate via an external network, such as the Internet or a LAN. In some embodiments, network controllers 225 may include a replaceable expansion card or adapter that is coupled to a motherboard connector of IHS 200. In some embodiments, a network controller 225 may be a PCIe switch, such as PCIe switches 165a-n described in computing cluster 100, while in other embodiments, the network controllers 255 of IHS 100 may include both a PCIe switch and a separate ethernet network controller. As described, a PCIe switch may be used by the IHS 200 to interface with other members of a computing cluster via a switch fabric 160.

IHS 200 may include one or more storage controllers 230 that may be utilized to access storage drives 240a-n that are accessible via a rack in which IHS 100 is installed. Storage controller 230 may provide support for RAID (Redundant Array of Independent Disks) configurations of logical and physical storage drives 240a-n. In some embodiments, storage controller 230 may be an HBA (Host Bus Adapter) that provide more limited capabilities in accessing physical storage drives 240a-n. In some embodiments, storage drives 240a-n may be replaceable, hot-swappable storage devices that are installed within bays provided by the chassis in which IHS 200 is installed. In embodiments where storage drives 240a-n are hot-swappable devices that are received by bays of chassis, the storage drives 240a-n may be coupled to IHS 200 via couplings between the bays of the chassis and a midplane of IHS 200. In some embodiments storage drives 240a-n may also be accessed by other IHSs that are also installed within the same chassis as IHS 100. Storage drives 240a-n may include SAS (Serial Attached SCSI) magnetic disk drives, SATA (Serial Advanced Technology Attachment) magnetic disk drives, solid-state drives (SSDs) and other types of storage drives in various combinations.

A variety of additional components may be coupled to processor(s) 205 via in-band bus 215. For instance, processor(s) 205 may also be coupled to a power management unit 260 that may interface with the power system unit 135 of the computing cluster 100 in which an IHS may be a member. In certain embodiments, a graphics processor 235 may be comprised within one or more video or graphics cards, or an embedded controller, installed as components of the IHS 200. In certain embodiments, graphics processor 235 may be an integrated component of the remote access controller 255 and may be utilized to support the display of diagnostic and administrative interfaces related to IHS 200 via display devices that are coupled, either directly or remotely, to remote access controller 255.

In certain embodiments, IHS 200 may operate using a BIOS (Basic Input/Output System) that may be stored in a non-volatile memory accessible by the processor(s) 205. The BIOS may provide an abstraction layer by which the operating system of the IHS 200 interfaces with the hardware components of the IHS. Upon powering or restarting IHS 200, processor(s) 205 may utilize BIOS instructions to initialize and test hardware components coupled to the IHS, including both components permanently installed as components of the motherboard of IHS 200 and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 255. In the evaluation of detected IHS hardware versus hardware identified in a factory-provisioned inventory certificate, BIOS may be configured to identify hardware components that are detected as being currently installed in IHS 200. In such instances, the BIOS may support queries that provide the described unique identifiers that have been associated with each of these detected hardware components by their respective manufacturers.

In some embodiments, IHS 200 may include a TPM (Trusted Platform Module) that may include various registers, such as platform configuration registers, and a secure storage, such as an NVRAM (Non-Volatile Random-Access Memory). The TPM may also include a cryptographic processor that supports various cryptographic capabilities. In IHS embodiments that include a TPM, a pre-boot process implemented by the TPM may utilize its cryptographic capabilities to calculate hash values that are based on software and/or firmware instructions utilized by certain core components of IHS, such as the BIOS and boot loader of IHS 200. These calculated hash values may then be compared against reference hash values that were previously stored in a secure non-volatile memory of the IHS, such as during factory provisioning of IHS 200. In this manner, a TPM may establish a root of trust that includes core components of IHS 200 that are validated as operating using instructions that originate from a trusted source.

As described, IHS 200 may include a remote access controller 255 that supports remote management of IHS 200 and of various internal components of IHS 200. In certain embodiments, remote access controller 255 may operate from a different power plane from the processors 205 and other components of IHS 200, thus allowing the remote access controller 255 to operate, and management tasks to proceed, while the processing cores of IHS 200 are powered off. As described, various functions provided by the BIOS, including launching the operating system of the IHS 200, may be implemented by the remote access controller 255. In some embodiments, the remote access controller 255 may perform various functions to verify the integrity of the IHS 200 and its hardware components prior to initialization of the operating system of IHS 200 (i.e., in a bare-metal state).

During a provisioning phase of the factory assembly of IHS 200, a signed inventory certificate that specifies factory installed hardware components of IHS 200 that were installed during manufacture of the IHS 200 may be stored in a non-volatile memory that is accessed by remote access controller 255. Using this signed inventory certificate stored by the remote access controller 255, a customer may validate that the detected hardware components of IHS 200 are the same hardware components that were installed at the factory during manufacture of IHS 200.

In support of the capabilities for validating the detected hardware components of IHS 200 against the inventory information that is specified in a signed inventory certificate, remote access controller 255 may include various cryptographic capabilities. For instance, remote access controller 255 may include capabilities for key generation such that remote access controller may generate keypairs that include a public key and a corresponding private key. As described in additional detail below, using generated keypairs, remote access controller 255 may digitally sign inventory information collected during the factory assembly of IHS 200 such that the integrity of this signed inventory information may be validated at a later time using the public key by a customer that has purchased IHS 200. Using these cryptographic capabilities of the remote access controller, the factory installed inventory information that is included in an inventory certificate may be anchored to a specific remote access controller 255, since the keypair used to sign the inventory information is signed using the private key that is generated and maintained by the remote access controller 255.

In some embodiments, the cryptographic capabilities of remote access controller 255 may also include safeguards for encrypting any private keys that are generated by the remote access controller and further anchoring them to components within the root of trust of IHS 200. For instance, a remote access controller 255 may include capabilities for accessing hardware root key (HRK) capabilities of IHS 200, such as for encrypting the private key of the keypair generated by the remote access controller. In some embodiments, the HRK may include a root key that is programmed into a fuse bank, or other immutable memory such as one-time programmable registers, during factory provisioning of IHS 200. The root key may be provided by a factory certificate authority, such as described below. By encrypting a private key using the hardware root key of IHS 200, the hardware inventory information that is signed using this private key is further anchored to the root of trust of IHS 200. If a root of trust cannot be established through validation of the remote access controller cryptographic functions that are used to access the hardware root key, the private key used to sign inventory information cannot be retrieved. In some embodiments, the private key that is encrypted by the remote access controller using the HRK may be stored to a replay protected memory block (RPMB) that is accessed using security protocols that require all commands accessing the RPMB to be digitally signed using a symmetric key and that include a nonce or other such value that prevents use of commands in replay attacks. Stored to an RPMG, the encrypted private key can only be retrieved by a component within the root of trust of IHS 200, such as the remote access controller 255.

Remote access controller 255 may include a service processor 255a, or specialized microcontroller, that operates management software that supports remote monitoring and administration of IHS 200. Remote access controller 255 may be installed on the motherboard of IHS 200 or may be coupled to IHS 200 via an expansion slot provided by the motherboard. In support of remote monitoring functions, network adapter 225c may support connections with remote access controller 255 using wired and/or wireless network connections via a variety of network technologies.

In some embodiments, remote access controller 255 may support monitoring and administration of various managed devices 220, 225, 230, 280 of an IHS via a sideband bus interface. For instance, messages utilized in device management may be transmitted using I2C sideband bus connections 275a-d that may be individually established with each of the respective managed devices 220, 225, 230, 280 through the operation of an I2C multiplexer 255d of the remote access controller. As illustrated, certain of the managed devices of IHS 200, such as non-standard hardware 220, network controller 225 and storage controller 230, are coupled to the IHS processor(s) 205 via an in-line bus 215, such as a PCIe root complex, that is separate from the I2C sideband bus connections 275a-d used for device management. The management functions of the remote access controller 255 may utilize information collected by various managed sensors 280 located within the IHS. For instance, temperature data collected by sensors 280 may be utilized by the remote access controller 255 in support of closed-loop airflow cooling of the IHS 200.

In certain embodiments, the service processor 255a of remote access controller 255 may rely on an I2C co-processor 255b to implement sideband I2C communications between the remote access controller 255 and managed components 220, 225, 230, 280 of the IHS. The I2C co-processor 255b may be a specialized co-processor or micro-controller that is configured to interface via a sideband I2C bus interface with the managed hardware components 220, 225, 230, 280 of IHS. In some embodiments, the I2C co-processor 255b may be an integrated component of the service processor 255a, such as a peripheral system-on-chip feature that may be provided by the service processor 255a. Each I2C bus 275a-d is illustrated as single line in FIG. 2. However, each I2C bus 275a-d may be comprised of a clock line and data line that couple the remote access controller 255 to I2C endpoints 220a, 225a, 230a, 280a which may be referred to as modular field replaceable units (FRUs).

As illustrated, the I2C co-processor 255b may interface with the individual managed devices 220, 225, 230, 280 via individual sideband I2C buses 275a-d selected through the operation of an I2C multiplexer 255d. Via switching operations by the I2C multiplexer 255d, a sideband bus connection 275a-d may be established by a direct coupling between the I2C co-processor 255b and an individual managed device 220, 225, 230, 280. In providing sideband management capabilities, the I2C co-processor 255b may each interoperate with corresponding endpoint I2C controllers 220a, 225a, 230a, 280a that implement the I2C communications of the respective managed devices 220, 225, 230. The endpoint I2C controllers 220a, 225a, 230a, 280a may be implemented as a dedicated microcontroller for communicating sideband I2C messages with the remote access controller 255, or endpoint I2C controllers 220a, 225a, 230a, 280a may be integrated SoC functions of a processor of the respective managed device endpoints 220, 225, 230, 280.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 205 as a systems-on-a-chip.

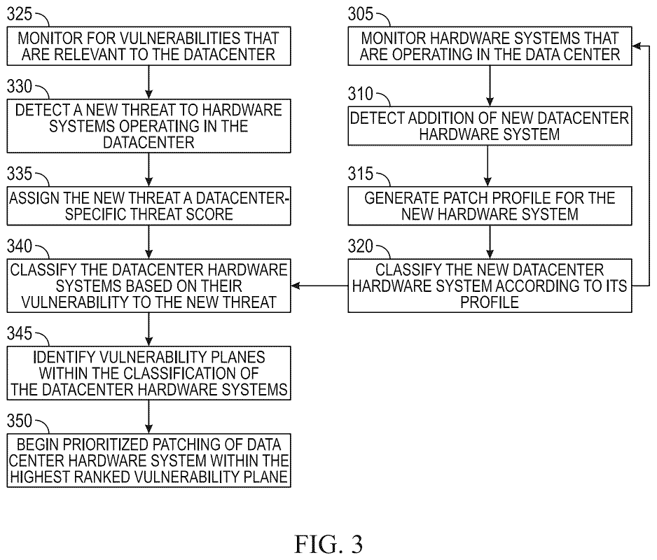

FIG. 3 is a diagram illustrating certain steps of a process 300, according to some embodiments, for supporting prioritized datacenter patch management. As described above, multi-network facilities such as datacenters operate complex, heterogeneous environments that include an array of different types of hardware systems, such as server IHSs. In such scenarios, the complexity and scale of patch management proposes substantial challenges. Once a patch is available for application within a datacenter, delays and inefficiencies in the installation of the patches results in increased vulnerability to security threats, potential system failures and costly downtime.

Some embodiments may begin, at 305, with monitoring of the hardware systems that are operating within a datacenter, such as each IHS 200 or other networking, storage, power and/or cooling system that may be installed in a rack-mounted chassis 100 of the datacenter. As each datacenter component is added or otherwise administered through the operation of remote tools 101, at 310, embodiments may generate a profile for each such hardware system of a datacenter that operates using instructions that may be patched in order to address security or other vulnerabilities that have been identified.

Some embodiments may build profiles, at 315, for each datacenter hardware system, identifying characteristics such as their manufacturer, model, operating system, firmware, attestation capabilities (e.g., via use of a factory-provisioned inventory certificate) and patch history, and may iteratively update these profiles each time a hardware system of the datacenter is administered through one of the remote management tools 101. In some embodiments, the profiling capabilities may collect and normalize profile data from hardware systems throughout the datacenter, thus identifying outliers and providing initial grouping of hardware systems by type, such as grouping the profiles for IHSs servers operating in the datacenter. Upon such processing, the profiles may then be categorized, at 320, in various manners for use in evaluating the relative vulnerability of different classifications of hardware systems to an identified threat, as described in additional detail below. As indicated in FIG. 3, embodiments may continually monitor and refine the profiles maintained for each of the hardware systems that are operating within the datacenter.

Also as indicated at 325 of FIG. 3, embodiments may include monitoring for security or other vulnerabilities that are relevant to the datacenter, and in some instances for which a patch is available for use. Embodiments may monitor data sources provided by IHS 100 manufacturer(s), entities providing support for IHSs 100, operating system providers, hardware component manufacturers and/or computer security companies and organizations. The vulnerabilities may include more traditional security vulnerabilities, such as software programs that include bugs or other flaws that could be compromised in order to gain access to or prevent operation of an IHS 100, and may also include other types of vulnerabilities that could allow a malicious actor to cause damage within the datacenter, such as to overload or otherwise disable power supply units of a chassis 100.

At 330, a new vulnerability is identified that is relevant to one or more hardware systems that are operating in the datacenter. Embodiments may assign an initial threat score for the vulnerability using a method such as through an adapted version of the CVSS (Common Vulnerability Scoring System) that provides a standard for evaluating the severity of vulnerabilities in computing systems. CVSS assigns a numerical score (0-10) to a vulnerability to indicate its potential impact on an a particular organization's security. In embodiments, the CVSS score may be generated based on the potential impact to the IHSs 100 and other hardware system that are operating in a specific datacenter.

In CVSS, higher scores indicate greater severity and thus indicate a need for faster mitigation strategies, including applying available patches. At 335, a new vulnerability is detected and a CVSS score may be calculated using a formula that considers several metrics that may be adapted for characterizing the potential impact of vulnerabilities within datacenters. For instance, a datacenter-specific CVSS score may be tabulated in part upon evaluation of Collateral Damage Potential (CDP) metric, which may characterize the potential for physical damage to any of the hardware systems that are operating in the datacenter, where this scoring metric may be elevated for possible damage to more specialized and more expensive hardware systems that would result in a greater economic loss if damaged due to an exploit. A datacenter-specific CVSS score may be further tabulated through evaluation of a Target Distribution (TD) metric, which may be based on a proportion of vulnerable hardware systems that are operating in the datacenter.

In some embodiments, multiple TD metrics may be tabulated, one for each different type of hardware system that is operating in the datacenter, such as a TD metric for IHS servers and another TD metric for network switches, thus providing an ability to separately distinguish and evaluate threats to networking, computing, storage, cooling and/or power hardware systems that are currently operating in the datacenter. A datacenter-specific CVSS score may be further tabulated through evaluation of a Confidentiality Requirement (CR) metric, which is based impacts to data confidentiality if a vulnerability is exploited, where this metric considers the confidentiality of the data that is currently stored in the datacenter. Hardware systems operating in the datacenter such as IHS servers providing streaming multimedia services would contribute relatively little to this metric, while IHS servers hosting a web based application used by medical facilities would contribute significantly to this datacenter-specific metric.

A datacenter-specific CVSS score may be further tabulated through evaluation of a Integrity Requirement (IR), which is based on the level of impact to data integrity if the vulnerability is exploited. Embodiments may consider factors such as the redundancy of stored data outside of the datacenter and the availability of backup and disaster recovery systems within the datacenter. A datacenter-specific CVSS score may be further tabulated through evaluation of an Availability Requirement (AR), which is based on the impact to datacenter availability (i.e., downtime) if a vulnerability is exploited. Embodiments may consider the specific backup and recovery capabilities of the individual hardware systems that are operating in the datacenter.

In some embodiments, an Adaptive Neuro Fuzzy Inference System (ANFIS) may be implemented to generate the datacenter-specific CVSS threat score using the CVSS metrics as inputs. In such embodiments, the CVSS metrics, such as the Attack Collateral Damage Potential (CDP), Target Distribution (TD), Confidentiality (CR), Integrity (IR), and Availability (AR) may be utilized as inputs to the ANFIS system. Through the operations of the ANFIS, these CVSS inputs are ‘fuzzified,’ such that the ANFIS tabulates a datacenter-specific threat score for a vulnerability despite the inherent uncertainty in the CVSS measurements used to characterize the vulnerability. For instance, values like “high” or “low” for a CVSS-based metric may be translated into fuzzy sets, with each fuzzy set representing a range of values.

The ANFIS may then utilize fuzzy inference rules to analyze the relationships between these CVSS inputs and may calculate a score characterizing the level of threat to the datacenter. The system may incorporate various rule-based interactions within the inference rules, such as: “If the Target Distribution are network switches and the privileges required for the exploit are low, then the threat level is high.” Through evaluation of such rules, the ANFIS may dynamically adjust the membership functions of the fuzzy sets. Such adjustments may be based on training data that includes historical vulnerability data of the datacenter and the impact of past vulnerabilities on datacenter security. Once these fuzzy rules are processed, the ANFIS generates a defuzzified output that provides a numerical threat score indicating the severity of the vulnerability for the specific data center.

Once a datacenter-specific threat score has been calculated, at 340, the datacenter hardware systems are classified according to their relative vulnerability to the new threat. As indicated in FIG. 3, the classification incorporates both the datacenter-specific threat score and the maintained profiles for hardware systems that are operating in the datacenter. Some embodiments may utilize a Random Forest Classifier (RFC) for categorizing the datacenter hardware systems based on their relative vulnerability to a security threat identified through its CVSS metrics and resulting datacenter-specific threat score. The RFC model may use a variety of input features derived from both the hardware systems operating in the datacenter and the CVSS-based metrics used to generate the threat score. For instance, the profile might include attributes such as the type of the hardware system (e.g., server, switch, firewall), the make and model, firmware versions, and whether the hardware is up-to-date with the latest security patches. Embodiments or the RFC model may utilize the datacenter-specific CVSS metrics as inputs in quantifying the exploitability and potential impact of any discovered vulnerabilities in the datacenter hardware systems. By combining both the datacenter-specific threat score and hardware-specific profile, the Random Forest model may be trained to understand how different hardware types, configurations, and vulnerabilities correlate with varying levels of risk with respect to specific types of vulnerabilities.

During training, the Random Forest Classifier may build a set of decision trees, each trained on a random subset of the available input data. Each tree is used to analyze the features and generate a prediction based on the relationships it uncovers between hardware system attributes and datacenter-specific CVSS score metrics. For example, the decision tree may consider that if a hardware system is operating using outdated firmware and the datacenter-specific metrics indicate elevated levels of risk across multiple different metrics, the hardware system may be classified as high risk. Conversely, hardware with a more robust configuration and the datacenter-specific threat score metrics indicate elevated levels of risk in only one metric might be classified as a medium risk. By training on a large set of labeled data, where each hardware system is already categorized according to its vulnerability level, the model learns how to categorize new hardware based on similar patterns.

Once the RFC model is trained, it may used to classify new or existing hardware in the data center. The Random Forest Classifier may process the input features (e.g., datacenter-specific threat scores and hardware system profile) and output a category for each hardware component—such as “Low Risk,” “Medium Risk,” or “High Risk.” The RFC model's ability to aggregate and evaluate multiple decision trees provides the ability to identify complex relationships within the data and to utilize those relationships in classifying the hardware systems with regard to their vulnerability to the new threat.

Once the hardware systems operating in the datacenter have been classified according to their vulnerability to the threat, at 345, embodiments may segregate the classified hardware systems into groups, by which patching of the hardware systems will be prioritized. For instance, embodiments may utilize a Support Vector Classifier (SVC) for grouping and thus prioritizing the patching of hardware systems in a datacenter, particularly when classifying and grouping hardware systems based on their vulnerability to a security threat. The SVC may operate through mapping of the hardware systems operating in the datacenter into a high-dimensional space, where the model may then classify the hardware systems into different priority groups based on features (i.e., vectors) derived from their vulnerabilities to the threat.

These features used as vectors would represent different aspects of a hardware system's security posture for use in the classification process. For example, in some embodiments, the SVC may segregate the hardware systems according to vulnerability planes, where the location of a hardware system in the vulnerability classification relative to a vulnerability plane may be based on vectors such as the datacenter-specific scoring metrics, hardware system criticality (core network switch vs. redundant data storage server IHS), network exposure (whether the hardware system is exposed to the internet or isolated within the datacenter behind firewalls), patch status, and the hardware system's role within the data center (e.g., a high-availability web server vs. a backup storage unit).

In some embodiments, the SVC may be implemented through the use of feature vectors that represent each hardware system's vulnerability. These vectors could include a range of numerical and categorical features, such as the datacenter-specific threat score, the exploitability (whether an exploit is available or known for the vulnerability), system criticality (with numerical values indicating how vital the hardware system is to the data center's operation, for example, with web servers hosting multimedia feeds being given a higher criticality score than file servers), and exposure (the level of network exposure).

Once the vectors that describe the classification of hardware systems according to the vulnerability to the threat are defined, the SVC model may be trained using historical data, where each hardware system is labeled according to its patching priority. The SVC model would learn to differentiate between high, medium, and low priority systems based on the patterns within the feature vectors. In some embodiments, the SVC model may operate by locating a vulnerability hyperplane that best separates the classified hardware systems into different patch priority groups. For instance, the SVC model may find the optimal boundary within the multi-dimensional space where hardware systems with similar vulnerability to the threat are grouped together based on their location relative to one of the vulnerability hyperplanes, while hardware systems with differing vulnerabilities are classified into separate groups.

After the SVC model is trained, it may be applied in the evaluation of hardware systems in the datacenter, where the model generate a priority classification for each hardware system based on its respective feature vectors. Hardware systems of the datacenter, as characterized by their profile and vulnerability classifications may be used as inputs to the SVC model, which would output a patch priority group (e.g., “High Priority,” “Medium Priority,” or “Low Priority”) for each hardware system, where the different priority groups are defined by the hyperplanes identified in the hardware system classification by the SVC model.

As indicated in FIG. 3, at 350, the groupings generated by the SVC model may be used to initiate prioritized patching of the hardware systems within the datacenter. For instance, the highest ranked grouping that is defined by the hyperplanes identified in the hardware system classification may be selected for initial and immediate patching. Once patching in this initial group has been completed, or no further patching in this group is currently possible, embodiments iterate to the next prioritized grouping of hardware systems to be updated.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method for managing a datacenter comprising a plurality of Information Handling Systems (IHSs), the method comprising:
maintaining profiles for hardware systems operating in the datacenter, wherein the profiles identify characteristics of the hardware systems, wherein the characteristics comprise attestation capabilities via use of a factory-provisioned inventory certificate, and wherein profile data collected from the hardware systems is normalized to identify outliers and provide initial groupings of the hardware systems by type;
detecting a security threat to one or more of the hardware systems operating in the datacenter;
assigning the security threat a datacenter threat score that characterizes vulnerability of the datacenter to the security threat based on the hardware systems operating in the datacenter;
classifying the hardware systems operating in the datacenter based on their relative vulnerability to the security threat and based in part on whether authenticity of the hardware systems may be validated using the factory-provisioned inventory certificate; and
prioritizing patching for each of the hardware systems operating in the datacenter based on a plurality of vulnerability hyperplanes that are identified in the vulnerability classification of the hardware systems operating in the datacenter.

2. The method of claim 1, wherein the datacenter threat score is generated from Common Vulnerability Scoring System (CVSS) metrics that characterize the vulnerability of the datacenter to security threats.

3. The method of claim 2, wherein the CVSS metrics are utilized as inputs to an Adaptive Neuro Fuzzy Inference System (ANFIS) that generates the datacenter threat score as an output.

4. The method of claim 3, wherein the CVSS metrics comprise a first target distribution metric for IHS server hardware systems that are operating in the datacenter.

5. The method of claim 3, wherein the CVSS metrics comprise a second target distribution metric for network switch hardware systems that are operating in the datacenter.

6. The method of claim 1, wherein the hardware systems operating within the datacenter comprise the plurality of IHSs and a plurality of network switches.

7. The method of claim 1, wherein the hardware systems operating in the datacenter are classified according to the vulnerability to the security threat through operation of a Random Forest Classifier.

8. The method of claim 7, wherein the Random Forest Classifier utilizes as inputs the datacenter threat score and the profiles maintained for the hardware systems operating in the datacenter.

9. The method of claim 1, wherein the vulnerability hyperplanes segregate the classified hardware systems into prioritized groupings of the hardware systems operating in the datacenter.

10. The method of claim 9, wherein the vulnerability hyperplanes are identified through operation of a Support Vector Classifier.

11. The method of claim 10, wherein vectors used by the Support Vector Classifier in classifying the hardware systems operating in the datacenter into one of the prioritized groupings comprise an importance of respective hardware systems to overall datacenter operations.

12. An Information Handling System (IHS) comprising:
one or more processors; and
one or more memory devices coupled to the one or more processors, the one or more memory devices configured with stored computer-readable instructions that, upon execution by the one or more processors, cause the IHS to:
maintain profiles for hardware systems in a datacenter, wherein the profiles identify characteristics of the hardware systems, wherein the characteristics comprise a manufacturer, a model, an operating system, firmware, attestation capabilities via use of a factory-provisioned inventory certificate, and patch history, and wherein profile data collected from the hardware systems is normalized to identify outliers and initially group the hardware systems by type;
detect a security threat to one or more of the hardware systems;
assign the security threat a datacenter threat score to characterize vulnerability of the datacenter to the security threat based on the hardware systems;
classify the hardware systems based on their relative vulnerability to the security threat and whether authenticity of the hardware systems may be validated based at least in part on the factory-provisioned inventory certificate; and
prioritize a patch for each of the hardware systems based on a plurality of vulnerability hyperplanes that are identified in the vulnerability classification of the hardware systems.

13. The IHS of claim 12, wherein the datacenter threat score is generated from Common Vulnerability Scoring System (CVSS) metrics that characterize vulnerability of the datacenter to security threats.

14. The IHS of claim 12, wherein the hardware systems comprise a plurality of IHSs and a plurality of network switches.

15. The IHS of claim 12, wherein the hardware systems are classified based at least in part on vulnerability to the security threat through operation of a Random Forest Classifier.

16. The IHS of claim 12, wherein the vulnerability hyperplanes segregate the classified hardware systems into prioritized groups of the hardware systems.

17. A non-transitory computer-readable storage device configured with instructions stored thereon for management of a datacenter, wherein execution of the instructions by one or more processors of an Information Handling System (IHS) causes the IHS to:
maintain profiles for hardware systems in the datacenter, wherein the profiles identify characteristics of the hardware systems, wherein the characteristics comprise a manufacturer, a model, an operating system, firmware, attestation capabilities via use of a factory-provisioned inventory certificate, and patch history, and wherein profile data collected from the hardware systems is normalized to identify outliers and initially group the hardware systems by type;
detect a security threat to one or more of the hardware systems;
assign the security threat a datacenter threat score to characterize vulnerability of the datacenter to the security threat based on the hardware systems;
classify the hardware systems based on their relative vulnerability to the security threat and whether authenticity of the hardware systems may be validated based at least in part on the factory-provisioned inventory certificate; and
prioritize a patch for each of the hardware systems based on a plurality of vulnerability hyperplanes that are identified in the vulnerability classification of the hardware systems.

18. The non-transitory computer-readable storage device of claim 17, wherein the datacenter threat score is generated from Common Vulnerability Scoring System (CVSS) metrics that characterize the vulnerability of the datacenter to security threats.

19. The non-transitory computer-readable storage device of claim 17, wherein the hardware systems comprise a plurality of IHSs and a plurality of network switches.

20. The non-transitory computer-readable storage device of claim 17, wherein the vulnerability hyperplanes segregate the classified hardware systems into prioritized groupings of the hardware systems.
